(19) United States
(12) Patent Application Publication
(10) Pub. No.: US 2023/0406703 A1
(43) Pub. Date: Dec. 21, 2023

(54) HYPOCHLORITE WATER PRODUCTION METHOD AND PRODUCTION APPARATUS

(71) Applicant: EVATEC CO., LTD., Tokyo (JP)

(72) Inventor: Minoru TERADA, Tokyo (JP)

(21) Appl. No.: 18/250,849

(22) PCT Filed: Oct. 30, 2020
(86) PCT No.: PCT/JP2020/040946

§ 371 Date: Apr. 27, 2023

(51) Int. Cl. C01B 11/04

(52) U.S. Cl. CPC C01B 11/04; C02F 1/50

(57) ABSTRACT

The subject is to provide a method and apparatus for producing hypochlorous acid solution of high concentration in a simple and easy manner without generating chlorine gas in principle. In the present invention to solve the above problem, an acidic aqueous solution with a pH of 1.5 to 5 and an aqueous solution containing hypochlorous acid aqueous solution are separately and independently prepared respectively, and both aqueous solutions are mixed to obtain hypochlorous acid water with a pH of 5 to 7.

### TECHNICAL FIELD

This invention relates to a method and apparatus for producing hypochlorite water.

### BACKGROUND ART

Conventionally, hypochlorous acid aqueous solutions (hereinafter referred to as hypochlorous acid solution) have been used as disinfectants or sanitizers in the medical, food, agricultural, and household fields. The disinfecting or sanitizing effect of hypochlorous acid aqueous solutions depends on the oxidizability of hypochlorous acid molecules and hypochlorous acid ions.

There are methods for producing hypochlorous acid aqueous solutions, including the electrolysis method using electrolysis of hypochlorite, the two-component method using a neutralization reaction between an aqueous hypochlorite (such as sodium hypochlorite) solution and an aqueous acid solution (such as hydrochloric acid), and the buffer method using a special ion exchanger to make the solution slightly acidic through an ion-exchange reaction.

For example, in the fields of food manufacturing plants and agriculture, it is necessary to use a large amount of hypochlorous acid solution as disinfection water. However, in the electrolysis method, expensive electrolysis devices are required to produce a large amount of hypochlorous acid solution. The amount of hypochlorous acid solution produced is insufficient and impractical.

In the two-component method, a mixture of tap water, well water, or other raw water and sodium hypochlorite is brought into contact with hydrochloric acid and reacted to produce a highly concentrated, weakly acidic hypochlorous acid solution (hypochlorous acid solution) that is effective for disinfection or sterilization. However, in the two-component method, chlorine gas is sometimes generated as a byproduct.

FIG. 3 is a schematic diagram of a producing apparatus using the two-component method in the conventional technology. This illustrated producing apparatus is designed to use hydrochloric acid and sodium hypochlorite as raw materials. In the producing apparatus of FIG. 3, water for dilution goes from faucet 31 through flow meter 32 to flow proportional dosing pump 33. Hydrochloric acid is fed from the hydrochloric acid tank 34 into the flow proportional dosing pump 33, and the hydrochloric acid is diluted by the water for dilution described above, leading to the next flow proportional dosing pump 36. The sodium hypochlorous acid aqueous solution is stored in the sodium hypochlorite tank 37, which is a separate tank from the hydrochloric acid tank 34, and this sodium hypochlorite solution is fed to the flow proportional injection pump 36 described above. The hydrochloric acid and sodium hypochlorous acid aqueous solution thus supplied to the flow-proportional injection pump 36 are mixed in the mixer 38. As a result of the mixing, hypochlorous acid solution is generated, the pH of the product is measured by the pH measuring apparatus 39, and the resulting hypochlorous acid solution is sprayed by the hypochlorous acid solution spraying apparatus 310.

As prior art to the buffer method, Patent Document 1 discloses an invention of a producing apparatus configured with the understanding that chlorine gas is not substantially generated when the pH is 3.5 or higher. The document discloses an invention of a producing apparatus that has a container filled with a weakly acidic ion exchanger for passing a hypochlorite solution, and is configured so that when the hypochlorite solution passes through the container, the pH does not drop below the pH at which chlorine gas is generated.

### PRIOR ART REFERENCES

### Patent Documents

[Patent document 1] JP5692657B

### SUMMARY OF INVENTION

### Technical Problem

The purpose of this invention is to provide a method and apparatus for producing hypochlorous acid solution safely and easily in a two-component method.

### Solution to Problem

The inventors have completed the following invention as a result of their diligent study.
(1) A producing method for hypochlorous acid aqueous solution with pH 5 to 7, comprising separately and independently preparing an acidic aqueous solution with pH 1.5 to 5 and an aqueous solution containing hypochlorite, respectively, and mixing both said aqueous solutions.
(2) The producing method according to (1), wherein the acidic aqueous solution is a hydrochloric acid aqueous solution.
(3) The producing method according to (1) or (2), wherein the hypochlorite is sodium hypochlorite.
(4) The producing method according to any one of (1) to (3), wherein the hypochlorous acid concentration of the hypochlorous acid solution is 2240 ppm or less.
(5) An apparatus for producing hypochlorous acid solution comprising;
   a first container that can contain an acidic aqueous solution,
   a second container that can contain aqueous solution containing hypochlorite, which is separate and independent from the first container,
   a mixer connected to the first and second containers via piping and capable of mixing the acidic aqueous solution and the aqueous solution containing hypochlorite,
   a pH measuring apparatus capable of measuring the pH of the hydrochloric acid to be fed to the mixer,
   wherein the piping is configured such that the contents of the first container and the contents of the second container do not come into contact with each other before being fed into the mixer,
   the hypochlorous acid aqueous solution is produced by mixing the acidic aqueous solution and the aqueous solution containing hypochlorite in the mixer.
(6) The apparatus according to (5), wherein the pH measuring apparatus comprises a memory means for storing a pH threshold value and a signal emitting means for signaling when the measured pH of the acidic aqueous solution is lower than the pH threshold value.
(7) The producing apparatus according to (5) or (6), further comprising a spraying apparatus connected to the mixer, wherein the spraying apparatus sprays the hypochlorous acid solution produced by the mixer.

### Advantageous Effects of Invention

According to the inventors' new findings, chlorine gas is substantially generated only when the pH environment is below 1.35 for hypochlorite ions. Therefore, if the pH of the acidic aqueous solution is adjusted to 1.5 to 5 in advance and then brought into contact with hypochlorous acid ions, the concern about the generation of chlorine gas is eliminated. Specifically, in the present invention, an aqueous solution containing hypochlorite is mixed with an acidic aqueous solution whose pH value is adjusted to 1.5 or higher. In the neutralization reaction, the pH of the acidic aqueous solution does not fall from the pH of the solution before the reaction, but rises, so that hypochlorous acid aqueous solution never reaches a pH below 1.5 in the producing process. Therefore, the concern of chlorine gas generation is eliminated during the entire producing process. Here, “practically no chlorine gas generation” means practically no chlorine gas generation at a level dangerous to living organisms, practically no chlorine bubbles can be seen generated from the solution when the pH of the hypochlorite solution is lowered, or practically no chlorine bleaching effect is observed when the pH of the hypochlorite solution is lowered. One of the standard conditions is that the unique pungent odor of chlorine is hardly noticeable when the generated hypochlorous acid aqueous solution is put into a glass or the like and smelled directly.

According to the device, hypochlorite water can be obtained safely and easily by the above-mentioned production method.

### BRIEF DESCRIPTION OF DRAWINGS

FIG. 1 is a plot of the measurement results in this example.

FIG. 2 is a schematic diagram of the device.

FIG. 3 is a schematic diagram of the manufacturing equipment in the conventional technology.

### DESCRIPTION OF EMBODIMENTS

The invention is described in detail below. In the two-component method, an aqueous solution of hypochlorite and an acidic aqueous solution are brought into contact to produce a neutralization reaction to obtain hypochlorous acid from hypochlorite. In the present invention, the acidic aqueous solution and the aqueous solution containing hypochlorite are prepared separately and independently. Preparing both aqueous solutions separately and independently of each other means that the two solutions are not brought into contact with each other until each solution has reached a predetermined pH and concentration. This prevents the generation of chlorine gas resulting from contact between the aqueous solution with an undesirably low pH and hypochlorite.

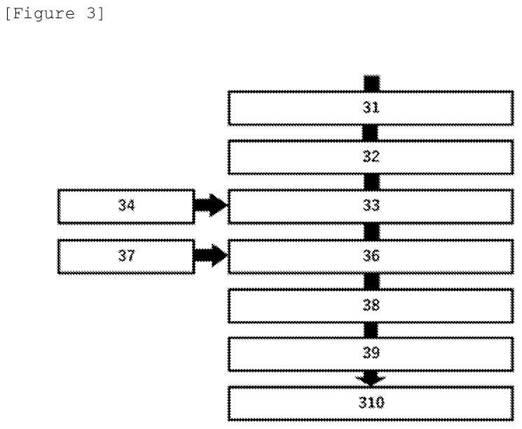

As mentioned above, in the conventional technology, chlorine gas was thought to be generated when the pH was less than 3.4. On the other hand, according to the conventional producing apparatus shown in FIG. 3 referenced above, commercially available concentrated hydrochloric acid (pH less than 1) was used in the hydrochloric acid tank 34. According to such a conventional producing apparatus, chlorine may be generated unwantedly, and for this reason, the use of an acidic solution with a pH in the range of 1 to 3.5 was not even considered on a dare.

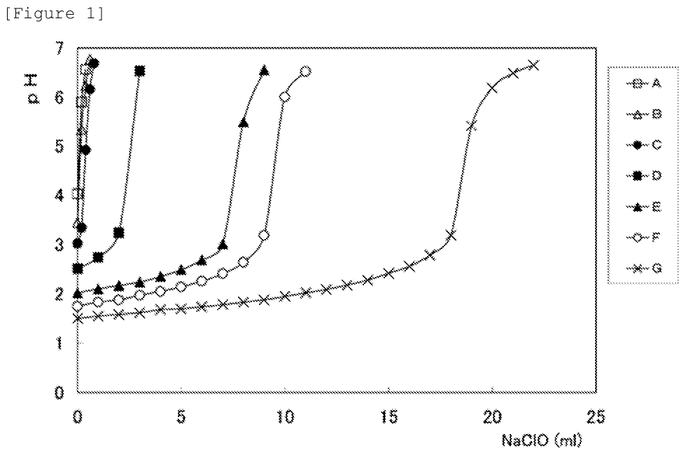

In contrast, in the present invention, the lower limit of pH of the acidic aqueous solution to be prepared is 1.5, and preferred lower limits include 1.75 and 2.0. The preferred upper limit of the pH of the acidic aqueous solution to be prepared is 2.1, and hypochlorous acid aqueous solution containing a much higher concentration of hypochlorous acid can be obtained when the pH is 2.1 or lower. In order to neutralize the alkaline hypochlorite solution, the pH of the acidic solution must be low, but on the other hand, a too low pH is inappropriate from the viewpoint of preventing the generation of chlorine gas. From these points of view, the above pH range is mentioned. Within the above range, the pH of the acidic aqueous solution to be prepared can be further set based on the concentration and pH of the hypochlorous acid solution to be finally obtained, taking into consideration the stoichiometry in the neutralization reaction to be described later. FIG. 1 is a plot of the amount of sodium hypochlorite added versus the pH of the product in the example described below. In setting the pH of the acidic aqueous solution to be prepared, the relationship between the amount added and pH as shown in FIG. 1 can also be used. The specifics of FIG. 1 are discussed in detail in the Examples section below.

The acid in the acidic solution is not limited, and hydrochloric acid, acetic acid, and citric acid are non-limiting. Hydrochloric acid and citric acid, which have less adverse effects on the human body, are preferred in consideration of the final hypochlorous acid solution to be obtained.

The concentration of hypochlorite to be prepared can be set by considering the concentration of hypochlorous acid solution to be finally obtained. Specifically, An aqueous solution containing 1 mole of hypochlorous acid aqueous solution can be obtained by neutralizing the solution containing 1 mole of hypochlorous acid ions with acid. The concentration of hypochlorite can be determined by considering the stoichiometry described above.

Hypochlorites are not limited, and typically include non-limiting alkali metal salts, such as sodium salts.

An example of how to set the pH and concentration of an acidic aqueous solution and an aqueous solution containing hypochlorous acid aqueous solution, prepared separately and respectively, is as follows.

The total volume of water and the amount of hypochlorite (ions) are determined from the target concentration of hypochlorous acid in the hypochlorous acid solution that is ultimately obtained. Based on the amount of acid required to neutralize hypochlorite to hypochlorous acid and the target pH in the final hypochlorous acid aqueous solution, the pH of the acidic solution to be pre-prepared is determined. These specific numerical examples can also be found in the examples and other examples described below.

The pH of the resulting hypochlorous acid solution is preferably 5 to 7, and 5.5 to 6.5 is more preferred. In the above pH range, it is possible to safely use the hypochlorous acid solution for foods, etc. and to obtain suitable sterilizing and disinfecting effects.

The concentration of hypochlorous acid in the resulting hypochlorous acid solution is not limited. The upper limit of the concentration of hypochlorous acid in this producing method, in which chlorine gas is not generated in principle, is preferably 2,440 ppm. Considering the cost of storage and transportation, sterilization and sanitization effects, etc., the concentration can be selected as long as it is below the above-mentioned upper limit.

There is no specific method for preparing the acid aqueous solution and the aqueous solution containing hypochlorous acid aqueous solution separately and independently, and the specific method for mixing the two aqueous solutions is not particularly limited, and methods in the conventional technology can be referred to as appropriate.

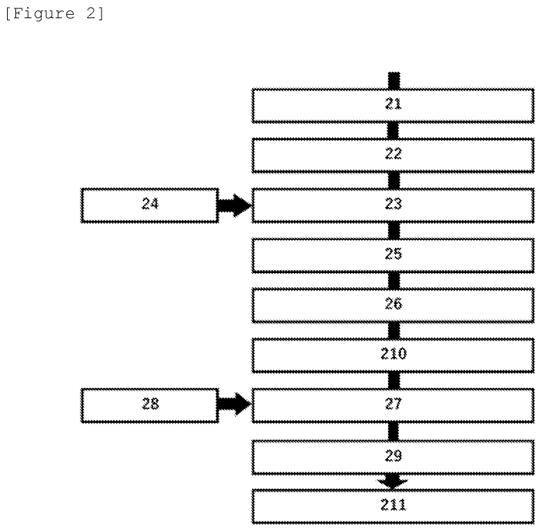

The present invention also provides a producing apparatus capable of producing hypochlorous acid solution by implementing the method described above. Said apparatus includes at least a first vessel, a second vessel, a mixer, piping connecting them and a pH measuring apparatus. FIG. 2 is a schematic diagram of the apparatus. FIG. 2 is depicted on the assumption that hydrochloric acid is used as the acidic aqueous solution and sodium hypochlorite is used as the hypochlorite. However, the invention is not limited to such use.

The first container is designed to contain an acidic aqueous solution with a pH of 1.5 to 5. The mixing tank indicated by the code 26 in FIG. 2 corresponds to the “first container”. The first container may simply be able to contain the liquid, or it may, for example, be further equipped with a mixing function with water for dilution, as described below. If the pH of the acidic solution is between 1.5 and 5, no chlorine gas is generated, and the producing method and specific examples of such acidic solution are as described above. The material, shape, etc. of the first container is not limited as long as it can contain said acidic aqueous solution, and examples include acid-resistant metal containers, glass containers, acid-resistant plastic containers, etc.

The apparatus described in FIG. 2 is equipped with a faucet 21 as a source of water for dilution, a flow meter 22, a flow proportional injection pump 23, a hydrochloric acid tank 24 as a container of raw acid before dilution, and a mixer 25 for diluting the acid with water in order to prepare the acidic solution to be contained in the first container.

The second container is for containing the hypochlorous acid aqueous solution containing hypochlorite. The sodium hypochlorite tank, indicated by the sign 28 in FIG. 2, corresponds to the “second container”. The producing method and properties of the aqueous solution containing hypochlorous acid aqueous solution are as described above. The material, shape, etc. of the second container is not limited as long as it can contain said aqueous solution, and examples include an alkali resistant metal container, a glass container, and an alkali resistant plastic container. In the apparatus of FIG. 2, the second container is indicated by the sign 28.

The first and second containers are provided separately and independently of each other. Provided separately and independently means that the contents of the first and second containers are separated to the extent that they do not mix without user manipulation.

The contents of the first and second containers are mixed in the mixing machine 29, indicated by the code 29. In the apparatus shown in FIG. 2, the contents of the mixing tank 26 and the contents of the sodium hypochlorite tank 28 are fed to the mixer 29 using a flow proportional dosing pump 27. The flow paths from the two tanks 26 and 28 to the mixer 29 are connected by piping, and the flow proportional dosing pump 27 described above constitutes all or part of the piping. The piping is configured such that the contents of mixing tank 26 and the contents of sodium hypochlorite tank 28 do not come into contact with each other before being fed to said mixer 29.

As mentioned above, the pH of the acidic solution supplied to the mixer 29 should be strictly controlled because contact between an acidic solution with a pH lower than a predetermined value and an aqueous solution containing hypochlorous acid aqueous solution increases the risk of chlorine gas generation. The apparatus is equipped with a pH measuring device to measure the pH of the acidic aqueous solution before it is fed to the mixer. In the apparatus shown in FIG. 2, the pH measuring device is indicated by the code 210. pH measuring devices such as commercially available pH meters can be used as appropriate.

If the acidic aqueous solution in the first container has an undesirably low pH, it is desirable to prevent contact with an aqueous solution containing hypochlorous acid aqueous solution. For this reason, the pH measurement apparatus 210 should be equipped with a memory means (not shown) that stores a pH threshold value and a signal emitting means (not shown) that signals when the measured pH of said acidic aqueous solution is lower than said pH threshold value. For example, a memory that stores information such as “the pH threshold value is 1.4” in the pH measurement apparatus 210 corresponds to said memory means. Signals emitted by said signal emitting means include a signal to stop driving the entire apparatus, a buzzer (sound) or warning light (light) to notify the user of an abnormality, and the like. When the actual measured pH value of the acidic solution is lower than the aforementioned threshold value, the above-mentioned signal is issued to automatically or by operation by the user to stop the driving of the apparatus and prevent the generation of chlorine gas.

In the apparatus, hypochlorous acid aqueous solution is generated by mixing an acidic aqueous solution and a hypochlorite-containing aqueous solution in the mixer 29 described above. The hypochlorous acid solution produced can be used as desired. Suitably, a spray apparatus is connected to the mixer 29, from which the hypochlorous acid solution can be sprayed. The spraying apparatus corresponds to the hypochlorite spraying apparatus indicated by the code 211 in the apparatus in FIG. 2. The spray apparatus can be made of any conventionally known material and form, and can be selected and used as appropriate.

### EXAMPLES

In the examples, the following parameters were measured as follows

pH: The pH in the reaction system was continuously measured with a portable pH meter HM-30P manufactured by Toa DKK.

Hypochlorous acid concentration: The effective chlorine concentration was measured and converted to hypochlorous acid concentration by Shibata Kagaku Corporation's Model AQ-202P effective chlorine concentration measuring kit.

Chlorine gas: The presence or absence of chlorine gas generation was determined by sensory inspection (odor).

### Example 1

First, hydrochloric acid was diluted with pure water to prepare dilute hydrochloric acid with a pH of 4.03. Separately from the dilute hydrochloric acid, a 100,000 ppm sodium hypochlorous acid aqueous solution was prepared. The pH and hypochlorous acid concentration were measured each time 0.2 ml of the above sodium hypochlorous acid aqueous solution was added to 1 liter of the above dilute hydrochloric acid. The amount of sodium hypochlorous acid aqueous solution added (denoted as “amount added”) and the pH (denoted as “pH”) and hypochlorous acid concentration (denoted as “hypochlorous acid concentration”) measured as described above are summarized below. Furthermore, the amount added is plotted on the horizontal axis and the pH on the vertical axis, FIG. 1, “A”. Thus, approximately 1 liter of hypochlorous acid solution (pH 6.56, concentration 42 ppm) was obtained. No odor of chlorine gas was produced from the start of producing to during and after producing.

| | | | Hypochlorous acid | |
|---|---|---|---|---|
| Amount added | | pH | concentration | |
| 0 | ml | 4.03 | 0 | ppm |
| 0.2 | ml | 5.90 | 26 | ppm |
| 0.4 | ml | 6.56 | 42 | ppm |

### Example 2

Approximately 1 liter of hypochlorous acid solution (pH 6.77, concentration 62 ppm) was obtained by the same process as in Example 1, except that the pH of the dilute hydrochloric acid to be prepared first was adjusted to 3.45 instead of 4.03. The “amount added,” “pH,” and “hypochlorous acid concentration” were measured as in Example 1. The measurement results are summarized below and further plotted in FIG. 1, “B,” with the amount added as the horizontal axis and pH as the vertical axis. No odor of chlorine gas was produced from the start of producing to during and after producing.

| | | | Hypochlorous acid | |
|---|---|---|---|---|
| Amount added | | pH | concentration | |
| 0 | ml | 3.45 | 0 | ppm |
| 0.2 | ml | 5.34 | 25 | ppm |
| 0.4 | ml | 6.23 | 39 | ppm |
| 0.6 | ml | 6.77 | 62 | ppm |

### Example 3

Approximately 1 liter of hypochlorous acid solution (pH 6.68, concentration 88 ppm) was obtained by the same process as in Example 1, except that the pH of the dilute hydrochloric acid to be prepared first was adjusted to 3.02 instead of 4.03. The “amount added,” “pH,” and “hypochlorous acid concentration” were measured as in Example 1. The measurement results are summarized below and further plotted in FIG. 1, “C,” with the amount added as the horizontal axis and pH as the vertical axis. No odor of chlorine gas was produced from the start of producing to during and after producing.

| | | | Hypochlorous acid | |
|---|---|---|---|---|
| Amount added | | pH | concentration | |
| 0 | ml | 3.02 | 0 | ppm |
| 0.2 | ml | 3.34 | 22 | ppm |
| 0.4 | ml | 4.92 | 48 | ppm |
| 0.6 | ml | 6.16 | 67 | ppm |
| 0.6 | ml | 6.68 | 88 | ppm |

### Example 4

First, dilute hydrochloric acid with pure water to prepare dilute hydrochloric acid with a pH of 2.51. Separately from the above dilute hydrochloric acid, a 100,000 ppm sodium hypochlorous acid aqueous solution was prepared. The pH and hypochlorous acid aqueous solution concentrations were measured each time 1 ml of the above sodium hypochlorite solution was added to 1 liter of the above dilute hydrochloric acid. The amount of sodium hypochlorous acid aqueous solution added (denoted as “amount added”) and the pH (denoted as “pH”) and hypochlorous acid concentration (denoted as “hypochlorous acid concentration”) measured as described above are summarized below and further plotted in FIG. 1, “D,” with the amount added as the horizontal axis and the pH on the vertical axis. Thus, approximately 1 liter of hypochlorous acid solution (pH 6.53, concentration 300 ppm) was obtained. No odor of chlorine gas was produced from the start of producing to during and after producing.

| | | Hypochlorous acid | |
|---|---|---|---|
| Amount added | pH | concentration | |
| 0 ml | 2.51 | 0 | ppm |
| 1 ml | 2.74 | 142 | ppm |
| 2 ml | 3.24 | 218 | ppm |
| 3 ml | 6.53 | 300 | ppm |

### Example 5

Approximately 1 liter of hypochlorous acid solution (pH 6.55, concentration 930 ppm) was obtained by the same process as in Example 4, except that the pH of the dilute hydrochloric acid was adjusted to 2.02 instead of 2.51 in the initial preparation. The “amount added,” “pH,” and “hypochlorous acid concentration” were measured as in Example 4. The measurement results are summarized below and further plotted in FIG. 1, “E,” with the amount added as the horizontal axis and pH as the vertical axis. No odor of chlorine gas was produced from the start of producing to during and after producing.

| | | Hypochlorous acid | |
|---|---|---|---|
| Amount added | pH | concentration | |
| 0 ml | 2.02 | 0 | ppm |
| 1 ml | 2.10 | 73 | ppm |
| 2 ml | 2.17 | 215 | ppm |
| 3 ml | 2.24 | 327 | ppm |
| 4 ml | 2.35 | 368 | ppm |
| 5 ml | 2.49 | 464 | ppm |
| 6 ml | 2.69 | 522 | ppm |
| 7 ml | 3.01 | 585 | ppm |
| 8 ml | 5.49 | 645 | ppm |
| 9 ml | 6.55 | 930 | ppm |

### Example 6

Approximately 1 liter of hypochlorous acid solution (pH 6.52, concentration 1150 ppm) was obtained by the same process as in Example 4, except that the pH of the dilute hydrochloric acid to be prepared first was adjusted to 1.75 instead of 2.51. The “amount added,” “pH,” and “hypochlorous acid concentration” were measured as in Example 4. The measurement results are summarized below and further plotted in FIG. 1, “F,” with the amount added as the horizontal axis and pH as the vertical axis. No odor of chlorine gas was produced from the start of producing to during and after producing.

| | | | Hypochlorous acid | |
|---|---|---|---|---|
| Amount added | | pH | concentration | |
| 0 | ml | 1.75 | 0 | ppm |
| 1 | ml | 1.83 | 133 | ppm |
| 2 | ml | 1.88 | 254 | ppm |
| 3 | ml | 1.97 | 312 | ppm |
| 4 | ml | 2.05 | 388 | ppm |
| 5 | ml | 2.14 | 440 | ppm |
| 6 | ml | 2.26 | 468 | ppm |
| 7 | ml | 2.41 | 585 | ppm |
| 8 | ml | 2.64 | 666 | ppm |
| 9 | ml | 3.19 | 788 | ppm |
| 10 | ml | 6.00 | 844 | ppm |
| 11 | ml | 6.52 | 1150 | ppm |

### Example 7

Approximately 1 liter of hypochlorous acid solution (pH 6.65, concentration 2240 ppm) was obtained by the same process as in Example 4, except that the pH of the dilute hydrochloric acid to be prepared first was adjusted to 1.50 instead of 2.51. The “amount added,” “pH,” and “hypochlorous acid concentration” were measured as in Example 4. The measurement results are summarized below and further plotted in FIG. 1, “G,” with the amount added as the horizontal axis and pH as the vertical axis. No odor of chlorine gas was produced from the start of producing to during and after producing.

| | | | Hypochlorous acid | |
|---|---|---|---|---|
| Amount added | | pH | concentration | |
| 0 | ml | 1.50 | 0 | ppm |
| 1 | ml | 1.55 | 111 | ppm |
| 2 | ml | 1.58 | 211 | ppm |
| 3 | ml | 1.62 | 294 | ppm |
| 4 | ml | 1.68 | 336 | ppm |
| 5 | ml | 1.70 | 405 | ppm |
| 6 | ml | 1.74 | 460 | ppm |
| 7 | ml | 1.78 | 496 | ppm |
| 8 | ml | 1.83 | 612 | ppm |
| 9 | ml | 1.88 | 696 | ppm |
| 10 | ml | 1.95 | 732 | ppm |
| 11 | ml | 2.02 | 768 | ppm |
| 12 | ml | 2.09 | 844 | ppm |
| 13 | ml | 2.18 | 872 | ppm |
| 14 | ml | 2.28 | 1056 | ppm |
| 15 | ml | 2.42 | 1215 | ppm |
| 16 | ml | 2.56 | 1386 | ppm |
| 17 | ml | 2.79 | 1519 | ppm |
| 18 | ml | 3.19 | 1544 | ppm |
| 19 | ml | 5.42 | 1680 | ppm |
| 20 | ml | 6.19 | 1850 | ppm |
| 21 | ml | 6.48 | 1930 | ppm |
| 22 | ml | 6.65 | 2240 | ppm |

### Comparative Example 1

First, dilute hydrochloric acid with pure water to prepare dilute hydrochloric acid with a pH of 1.35. Separately from the above dilute hydrochloric acid, a 100,000 ppm sodium hypochlorous acid aqueous solution was prepared. 1 ml of the above sodium hypochlorous acid aqueous solution was added to 1 liter of the above dilute hydrochloric acid. After the addition, the reaction solution was stirred while the pH of the solution was continuously measured. The pH gradually increased and eventually stabilized, but the odor of chlorine gas was generated after about 1 hour. For safety reasons, the process was terminated at this stage. As a result, in this example, hypochlorous acid solution could not be obtained in a safe process.

### Comparative Example 2

The same process as in Comparative Example 1 was attempted, except that the pH of the dilute hydrochloric acid initially prepared was adjusted to 1.30 instead of 1.35. When 1 ml of the above sodium hypochlorous acid aqueous solution was added to 1 liter of the above dilute hydrochloric acid, the reaction solution turned yellow after a few minutes and the odor of chlorine gas was generated. For safety reasons, the treatment was terminated at this stage. As a result, in this example, hypochlorous acid solution could not be obtained in a safe process.

### Comparative Example 3

The same process as in Comparative Example 1 was attempted except that the pH of the dilute hydrochloric acid initially prepared was adjusted to 1.15 instead of 1.35. When 1 ml of the above sodium hypochlorous acid aqueous solution was added to 1 liter of the above dilute hydrochloric acid, the reaction solution turned yellow after a few minutes and the odor of chlorine gas was generated. For safety reasons, the treatment was terminated at this stage. As a result, in this example, hypochlorous acid solution could not be obtained in a safe process.

### Example 8

First, citric acid solution with a pH of 1.88 was prepared by diluting citric acid with pure water. Separately from the above citric acid solution, a 100,000 ppm sodium hypochlorous acid aqueous solution was prepared. 40 ml of the above sodium hypochlorous acid aqueous solution was added to 50 ml of the above citric acid solution. After the addition, the reaction solution was stirred while the pH of the solution was continuously measured. The pH gradually increased and the pH value stabilized at 6.00. The hypochlorous acid concentration obtained by the neutralization reaction at this time corresponds to 44400 ppm. Thus, about 90 ml of hypochlorous acid solution (pH 6.00) was obtained. No odor of chlorine gas was produced during or after this producing process. Therefore, this example is also an embodiment of the invention.

### Example 9

Approximately 61 ml of hypochlorous acid aqueous solution was obtained by the same process as in Example 8, except that the pH of the citric acid solution prepared first was adjusted to 2.01 instead of 1.88 and the amount of 100,000 ppm sodium hypochlorite solution separately prepared for 50 ml of the citric acid solution was changed to 11 ml. The same treatment as in Example 8 was used to obtain approximately 61 ml of hypochlorite water. The hypochlorous acid concentration obtained by the neutralization reaction is equivalent to 18,000 ppm. The pH of the hypochlorous acid solution was measured to be 6.19, and no chlorine gas odor was produced during or after producing the solution. Therefore, this example is also an embodiment of the invention.

### Example 10

Approximately 51 ml of hypochlorous acid aqueous solution was obtained by the same process as in Example 8, except that the pH of the citric acid solution prepared first was adjusted to 2.75 instead of 1.88 and the amount of 100,000 ppm sodium hypochlorite solution separately prepared was changed to 1 ml for 50 ml of this citric acid solution. was obtained. The hypochlorous acid concentration obtained by the neutralization reaction was equivalent to 1900 ppm. The pH of this hypochlorous acid solution was measured to be 6.04, and no chlorine gas odor was produced during or after producing this solution. Therefore, this example is also an embodiment of the invention.

### Example 11

The pH of the citric acid aqueous solution prepared first was adjusted to 3.05 instead of 1.88, and the amount of 100,000 ppm sodium hypochlorous acid aqueous solution separately prepared was changed to 0.3 ml for 50 ml of the citric acid aqueous solution. The hypochlorite water obtained from the neutralization reaction was about 50.3 ml. The hypochlorous acid concentration obtained by the neutralization reaction corresponds to 596 ppm. The pH of the hypochlorous acid solution was measured to be 6.24, and no chlorine gas odor was produced during or after producing the solution. Therefore, this example is also an embodiment of the invention.

In the above, an exemplary embodiment of the invention has been described in detail. Various modifications and additions may be made without departing from the spirit and scope of the invention. Features of each of the various embodiments described above can be combined with features of other embodiments described as necessary to provide combinations of multiple features in related new embodiments. Furthermore, while the above description describes embodiments of the method and apparatus of the invention, they are merely illustrative of the application of the principles of the invention.

### REFERENCE SIGNS LIST

21 Water faucet
22 Flow meter
23 Flow-proportional dosing pump
24 Hydrochloric acid tank
25 Mixer 26 Mixing tank
27 Flow proportional dosing pump
28 Sodium hypochlorite tank
29 Mixer
210 pH measuring apparatus
211 Hypochlorous acid spray apparatus
31 Water faucet
32 Flow meter
33 Flow proportional dosing pump
34 Hydrochloric acid tank
36 Flow proportional dosing pump
37 Sodium hypochlorite tank
38 Mixer
39 pH measuring apparatus
310 Hypochlorous acid spray apparatus

1. A producing method for hypochlorous acid aqueous solution with pH 5 to 7, comprising separately and independently preparing an acidic aqueous solution with pH 1.5 to 5 and an aqueous solution containing hypochlorite, respectively, and mixing both said aqueous solutions.

2. The producing method according to claim 1, wherein the acidic aqueous solution is a hydrochloric acid aqueous solution.

3. The producing method according to claim 1, wherein the hypochlorite is sodium hypochlorite.

4. The producing method according to claim 1, wherein the hypochlorous acid concentration of the hypochlorous acid solution is 2240 ppm or less.

5. An apparatus for producing hypochlorous acid solution comprising;
a first container that can contain an acidic aqueous solution,
a second container that can contain aqueous solution containing hypochlorite, which is separate and independent from the first container,
a mixer connected to the first and second containers via piping and capable of mixing the acidic aqueous solution and the aqueous solution containing hypochlorite,
a pH measuring apparatus capable of measuring the pH of the acidic aqueous solution to be fed to the mixer,
wherein the piping is configured such that the contents of the first container and the contents of the second container do not come into contact with each other before being fed into the mixer,
the hypochlorous acid aqueous solution is produced by mixing the acidic aqueous solution and the aqueous solution containing hypochlorite in the mixer.

6. The apparatus according to claim 5, wherein the pH measuring apparatus comprises a memory means for storing a pH threshold value and a signal emitting means for signaling when the measured pH of the acidic aqueous solution is lower than the pH threshold value.

7. The producing apparatus according to claim 5, further comprising a spraying apparatus connected to the mixer, wherein the spraying apparatus sprays the hypochlorous acid solution produced by the mixer.

8. A method for inhibiting the generation of chlorine gas while producing hypochlorous acid aqueous solution having a pH of 5 to 7 by mixing an acidic aqueous solution and an aqueous solution containing hypochlorite, comprising adjusting the pH of the acidic aqueous solution to 1.5 to 5.

9. The method according to claim 8, wherein the acidic aqueous solution is a hydrochloric acid aqueous solution.

10. The producing method according to claim 8, wherein the hypochlorite is sodium hypochlorite.

11. The producing method according to claim 8, wherein the hypochlorous acid concentration of the hypochlorous acid solution is 2240 ppm or less.
